(19) United States
(12) Patent Application Publication
(10) Pub. No.: US 2019/0311564 A1
(43) Pub. Date: Oct. 10, 2019

(54) COIN PROCESSING DEVICE

(71) Applicant: GLORY LTD., Himeji-shi, Hyogo (JP)

(72) Inventors: Akihisa OHNO, Himeji-Shi, Hyogo (JP); Shuji ONISHI, Himeji-Shi, Hyogo (JP); Daiki TANAKA, Himeji-Shi, Hyogo (JP); Yusuke YOSHIDA, Himeji-Shi, Hyogo (JP)

(73) Assignee: GLORY LTD., Himeji-shi, Hyogo (JP)

(21) Appl. No.: 16/465,952

(22) PCT Filed: Nov. 30, 2017
(86) PCT No.: PCT/JP2017/043083

§ 371 Date: May 31, 2019

(30) Foreign Application Priority Data
Dec. 1, 2016 (JP) 2016-233861

(51) Int. Cl. G07D 3/06; G07D 9/00

(52) U.S. Cl. CPC G07D 3/06; G07D 9/00

(57) ABSTRACT

Disclosed is a coin handling apparatus 1 including: a transport unit 8 including a transport disk which moves a coin along a coin track; sorting units each of which sorts the coin when the coin falls into any of openings; a fall detector which detects the opening into which the coin has fallen; a motor which allows the transport disk to rotate; and a controller (controller) which stops the motor upon determining an occurrence of a transport error in the coin track, and identifies the opening into which the coin has fallen after the stop of the motor and during recovery from the transport error based on a detection result of the fall detector.

### CROSS-REFERENCE TO RELATED APPLICATIONS

This application is a National Stage Application of PCT/JP2017/043083, filed Nov. 30, 2017, which claims the benefit of and priority to Japanese Patent Application No. 2016-233861, filed Dec. 1, 2016, both of which are incorporated herein by reference in their entireties.

### TECHNICAL FIELD

The present disclosure relates to a coin handling apparatus.

### BACKGROUND

U.S. Pat. No. 7,704,133 describes a desktop coin handling apparatus. The coin handling apparatus includes: an arcuate coin track along which coins are moved; and a transport unit configured to move the coins along the coin track in a single layer and a single file using a disk assembly. While the disk assembly sandwiches the coins between its lower surface and the coin track, the disk assembly rotates about a shaft, and thus moves the coins in a single layer and a single file along the coin track. The coin handling apparatus includes a sorting unit in the coin track. The sorting unit has one opening for rejecting the coins, and six openings for sorting the coins by diameter. Coins that have fallen into any of the openings enters a drawer. This coin handling apparatus is able to sort valid coins by six denominations and reject invalid coins.

### SUMMARY

In the coin handling apparatus described in Patent Document 1, when a transport error (for example, jamming of the coins) occurs in the coin track, an operator detaches the disk assembly from a body of the apparatus for recovery from the transport error. Then, the operator removes the coins remaining in the coin track.

When the disk assembly is detached from the body of the apparatus, the disk assembly may sometimes rotate. With the rotation of the disk assembly, the coin sandwiched between the disk assembly and the coin track may possibly move, and then fall into any of the openings. If the operator does not notice that the coin has fallen during the recovery from the transport error, and the coin that has fallen remains in the drawer, a count error may possibly occur.

In view of the foregoing, it is therefore an object of the present disclosure to detect, in a coin handling apparatus configured to sort coins, whether a coin has fallen into an opening during the recovery from the transport error.

The present disclosure relates to a coin handling apparatus. The coin handling apparatus comprises: an arcuate coin track configured to move a coin; a transport unit comprising a transport disk that rotates about a shaft, the transport unit rotating with pressing an upper surface of the coin by a lower surface of the transport disk so as to move the coin in a single layer and a single file along the coin track; a sorting unit comprising a plurality of openings provided in the coin track, and sorting the coin by making the coin moving along the coin track fall into any of the openings; a fall detector configured to detect the opening into which the coin has fallen; a motor configured to allow the transport disk to rotate; and a controller configured to stop the motor upon determining an occurrence of a transport error of the coin in the coin track, and identify the opening into which the coin has fallen in a period from the stop of the motor to the end of recovery from the transport error based on a detection result of the fall detector.

In the coin handling apparatus configured in this manner, the coins are moved along the arcuate coin track by the rotation of the transport disk. The sorting unit makes each of the coins moving the transport track fall into any one of the openings to sort the coins.

Determining that a transport error of the coins has occurred in the coin track, the controller stops the motor. The controller may determine that the transport error has occurred, for example, based on a current value supplied to the motor, or on an angle of rotation of the transport disk detected by an encoder or any other component. When a transport error has occurred, an operator performs an error recovery operation.

The transport disk may be arranged to face the coin track so as to sandwich the coin between the lower surface of the transport disk and the coin track when the transport disk moves the coin, and the lower surface of the transport disk during the recovery from the transport error is at a position further away from the coin track than a position at which the transport disk moves the coin. In other words, the transport disk can be lifted upward from the coin track. As one configuration example, the transport disk may be completely detachable from a body of the coin handling apparatus.

When the lower surface of the transport disk is separated from the coin track, the operator can manually remove the coins from the coin track. Thus, the operator can remove a cause of the transport error, e.g., coins jammed in the coin track.

At the time of separating the lower surface of the transport disk from the coin track, the transport disk may rotate, and the coins in the coin track may possibly fall into any of the openings. In the above-described configuration, however, the fall detector detects the opening into which the coin has fallen in a period from the stop of the motor to the end of the recovery from the transport error. Thus, the operator of the coin handling apparatus can recognize the opening in which the coin has fallen. Note that, if no coin falls into any of the openings, the recovery from the transport error can be finished after the coin on the coin track, if any, is removed.

The coin handling apparatus may include a display configured to display the opening into which the coin has fallen for the period from the stop of the motor to the end of the recovery from the transport error.

This allows the operator to know which opening the coin has fallen into by looking at information displayed on the display. The operator can remove the coins entered a drawer, as necessary. Since the coins are appropriately removed, the occurrence of a trouble, such as a count error can be avoided.

The coin handling apparatus may include a rotational angle detector configured to detect an angle of rotation of the transport disk.

The coin handling apparatus includes: a recognition unit configured to recognize the coin; and a rotational angle detector configured to detect an angle of rotation of the transport disk, wherein the sorting unit comprises a driving sorting unit which is arranged downstream of the recognition unit in a direction of movement of the coin, and is configured to selectively drop the coin into an associated one of the openings based on a recognition result and the angle of rotation of the transport disk, and the controller identifies, based on a detection result of the fall detector and a detection result of the rotational angle detector, a position of the coin for the period from the stop of the motor to the end of the recovery from the transport error, the coin having already passed through the recognition unit when the transport error occurred.

After passing through the recognition unit, the coin recognized by the recognition unit is moved along the coin track by the transport disk. An angle of rotation of the transport disk is in approximate agreement with a movement amount of the coin. When the rotational angle detector detects the angle of rotation of the transport disk, the position of the coin moving after passing through the recognition unit can be identified at any time. When a predetermined coin has arrived at the position of the driving sorting unit, the driving sorting unit drops the predetermined coin into an associated one of the openings based on the recognition result and the angle of rotation of the transport disk. Thus, the driving sorting unit can selectively drop the coin into the opening.

Based on the recognition result of the recognition unit (i.e., information about the time when the coin passed through the recognition unit) and the detection result of the rotational angle detector, the controller can identify the position on the coin track of the coin that had already passed through the recognition unit when the transport error occurred. Furthermore, the amount of movement of the coin on the coin track and the opening into which the coin has fallen can be estimated based on the angle of rotation of the transport disk that has rotated when the transport disk is lifted up from the coin track for the recovery from the transport error and the detection result of the fall detector. Moreover, the coin that has not fallen and remaining on the coin track can also be identified. Based on the positional information of the coin, the operator can appropriately remove the coin from the coin track or the drawer during the recovery from the error.

The coin handling apparatus may include a display unit configured to display an identification result of the controller, wherein the display displays the opening into which the coin has fallen for the period from the stop of the motor to the end of the recovery from the transport error.

This allows the operator to appropriately remove the coin from the drawer during the recovery from the error according to the contents displayed on the display. Note that, in the case where no coin has fallen into the opening, the display may display that no coin has fallen, or display nothing.

The display may display a position of the coin remaining on the coin track.

This allows the operator to appropriately remove the coin from the coin track during the recovery from the error.

The display may display the opening into which the coin has fallen, and information based on the recognition result for identifying the coin that has fallen into the opening. The information for identifying the coin includes information on the currency of the coin and information on the denomination of the coin. The information may also include information indicating that the coin is a counterfeit coin or an unfit coin.

When the opening into which the coin has fallen and the information for identifying the coin that has fallen are displayed, the operator can tell which coin, if entered the drawer, should be removed from the drawer. The operator can appropriately remove the coin from the drawer.

The controller may determine, based on the identification result, that the coin has fallen into an inappropriate one of the openings in a period from the stop of the motor to the end of the recovery from the transport error, and the display may display that the coin has fallen into the inappropriate one of the openings.

For example, suppose that the transport error has occurred when the coin handling apparatus is sorting the coins by denomination. When the coin erroneously falls into an inappropriate opening which is for the coins of a different denomination in the period from the stop of the motor to the end of the recovery from the transport error, the controller determines that the coin has fallen into the inappropriate opening, and the display indicates that the coin has fallen into the inappropriate opening. Based on the displayed information, the operator can recognize that the coin in the drawer needs to be removed. As a result, the operator can remove the coin appropriately from the drawer. When the coin has fallen into an appropriate opening, counting of the coins is performed, and the display may or may not indicate the fall of the coin.

The coin handling apparatus may include: a feeding unit comprising a rotating plate that rotates about a shaft, and separately feeding the coin on the rotating plate to the coin track by rotation of the rotating plate; a belt wound around a first pulley that is allowed to rotate by the motor and the shaft of the transport disk, and configured to transfer a rotary force of the motor to the transport disk; and a second pulley attached to the rotating plate, and arranged to be in contact with a back surface of the belt between the first pulley and the shaft of the transport disk, so that the rotating plate rotates in a direction opposite to a direction of rotation of the transport disk while the belt is running.

In this configuration, when the motor allows the first pulley to rotate, the transport disk coupled to the first pulley via the belt rotates. Further, when the belt runs, the rotating plate rotates via the second pulley. Thus, the single motor allows both the rotating plate of the feeding unit and the transport disk to rotate. Since the same motor is used to rotate the rotating plate and the transport disk, the coin handling apparatus can be downsized and simplified in structure.

Since the belt is directly wound around the shaft of the transport disk, the motor allows the transport disk to stably rotate. Thus, the coins are stably moved on the coin track, which stabilizes the sorting of the coins. In particular, this allows the coin handling apparatus including the driving sorting unit which selectively sorts the coins based on the recognition result of the recognition unit and the angle of rotation of the transport disk to perform correct sorting of the coins. In this example, the belt is directly wound around the shaft of the transport disk, but a pulley may be attached to the shaft of the transport disk, and the belt may be wound around the pulley.

The coin handling apparatus may include a rotational speed detector configured to detect a rotational speed of the rotating plate, wherein the controller may compare a detection result of the rotational angle detector and a detection result of the rotational speed detector to determine whether a feeding error has occurred in the feeding unit.

When the motor is shared, it becomes difficult to distinguish the occurrence of a feeding error in the feeding unit and the occurrence of a transport error in the coin track.

Meanwhile, since the rotating plate of the feeding unit is rotated by the second pulley making contact with the back surface of the belt, slippage occurs between the second pulley and the belt when the coin is stuck in the feeding unit, for example.

Thus, in the above-described configuration, the angle of rotation of the transport disk detected by the rotational angle detector is compared with the rotational speed of the rotating plate of the feeding unit detected by the rotational speed detector to determine whether the feeding error has occurred in the feeding unit. For example, if the rotation of the rotating plate of the feeding unit lags behind a change in the angle of rotation of the transport disk, it can be determined that the feeding error has occurred in the feeding unit. Thus, the occurrence of the feeding error in the feeding unit can be determined in distinction from the occurrence of the transport error.

The transport error in the coin track occurs relatively less frequently because the transport disk moves the coins in a single layer and a single file along the coin track. When the transport error occurs in the coin track, it is desirable to stop the motor to suspend the handling by the coin handling apparatus, and the operator performs an error removal operation so that the coins are not erroneously sorted. In contrast, the feeding error in the feeding unit occurs more frequently than the transport error. However, as will be described later, the handling can be continuously performed without the error recovery operation by the operator as long as the coin handling apparatus automatically recovers from the error. Thus, as described above, if the coin handling apparatus is configured to avoid the suspension of the handling in the event of the feeding error by distinguishing the feeding error in the feeding unit from the transport error in the sorting unit, the number of suspension of the coin handling apparatus can be reduced, and the sorting of the coins can be smoothly finished.

Determining that the feeding error has occurred, the controller may stop the motor and reverse the direction of rotation of the motor to allow the rotating plate to rotate in a direction opposite to a feeding direction of the coins, and then resume driving the motor to allow the rotating plate to rotate in the feeding direction of the coins.

The inventors' study has revealed that the recovery from the feeding error can be achieved by rotating the motor in the reverse direction in the event of the feeding error to rotate the rotating plate in a direction opposite to the feeding direction of the coins. Thus, when the feeding error has occurred, the coin handling apparatus can automatically recover from the feeding error.

The controller may reverse the direction of rotation of the motor so that the transport disk rotates in the opposite direction at an angle of rotation of 10 degrees or less, when the controller rotates the rotating plate in the opposite direction.

In the coin handling apparatus configured as described above, the same motor is used to rotate the rotating plate of the feeding unit and the transport disk in the sorting unit. Hence, when the rotating plate of the feeding unit rotates in the opposite direction, the transport disk also rotates in the direction opposite to the direction of movement of the coins. When the transport disk rotates in the opposite direction, the coins also move in the direction opposite to the normal movement direction. The inventors' study has revealed that, when the coins greatly move in the opposite direction, trouble may possibly occur in the transport and sorting of the coins after the driving of the motor is resumed. Therefore, the angle of rotation of the transport disk in the opposite direction is preferably limited to 10° degrees or less, more preferably 3° to 5°. When the angle of the rotation in the opposite direction is set to 3° to 5°, the recovery from the feeding error can be achieved with reliability, and the trouble in the transport and sorting of the coins after the driving of the motor is resumed can be avoided.

The rotational angle detector may be an encoder provided for the shaft of the transport disk and configured to output a signal to the controller in accordance with the rotation of the transport disk.

This allows the angle of rotation of the transport disk to be detected with high precision. The position of the coin that has passed through the recognition unit can be accurately identified. As a result, the driving sorting unit can drop a predetermined coin accurately into an associated one of the openings in accordance with the signal from the encoder. In addition, the angle of rotation of the transport disk at the time when the operator performs an operation for the recovery from the transport error can also be detected with high precision, and thus, the position of the coin at the time of the recovery from the error can be accurately identified.

The rotational speed detector may be configured to detect that a projection provided for the rotating plate revolves in accordance with the rotation of the rotating plate.

The detection accuracy of the rotational speed of the rotating plate of the feeding unit may be lower than that of the angle of rotation of the transport disk. When the rotational speed detector is configured to detect the revolutions of a projection provided for the rotating plate with a suitable device such as a photosensor or a proximity sensor, the rotational speed detector can be implemented at low cost.

As can be seen in the foregoing, the above-described coin handling apparatus can detect whether the coin has fallen into an opening during the recovery from a transport error.

### BRIEF DESCRIPTION OF THE DRAWINGS

FIG. 1 is a perspective view illustrating an external appearance of a coin handling apparatus.

FIG. 2 is a perspective view illustrating an internal configuration of the coin handling apparatus.

FIG. 3 is a plan view of a handling unit.

FIG. 4 is a cross-sectional view taken along line IV-IV of FIG. 3.

FIG. 5 is a perspective view of a transport disk.

FIG. 6 is a plan view illustrating a drive configuration of the transport disk and rotating plate of the coin handling apparatus.

FIG. 7 is a block diagram illustrating a configuration of the coin handling apparatus.

FIG. 8 shows a plan view of a drawer at the top, and a cross-sectional view of the drawer at the bottom.

FIG. 9 is a flowchart illustrating control for recovery from an error in the coin handling apparatus.

FIG. 10 is an on-screen image which is displayed on a display during recovery from a transport error.

FIG. 11 is a timing chart illustrating control for recovery from a feeding error in a feeding unit.

### DETAILED DESCRIPTION

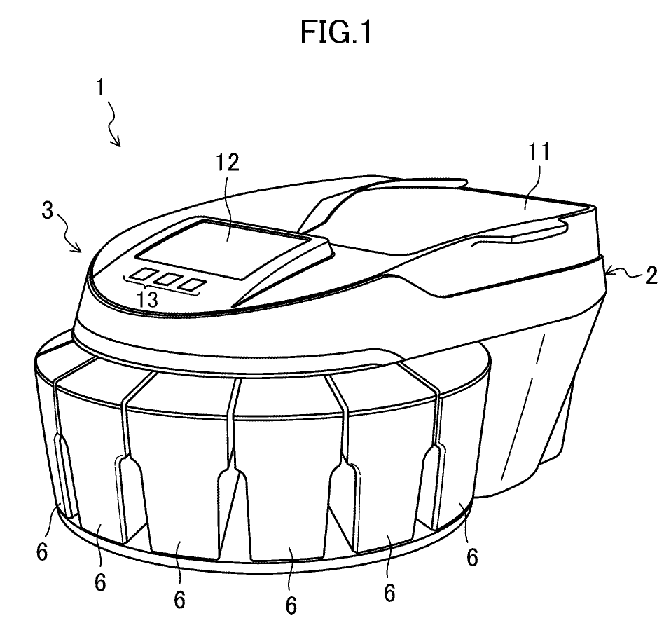

A coin handling apparatus disclosed herein will be described in detail below with reference to the drawings. Note that the following description is merely an exemplary one in nature. FIG. 1 illustrates an external appearance of a coin handling apparatus 1. The coin handling apparatus 1 is a desktop apparatus. In the following description, for the sake of convenience, a front left side of the apparatus illustrated on the paper of FIG. 1 will be referred to as a “front side” of the coin handling apparatus, and a rear right side of the apparatus illustrated on the paper will be referred to as a “rear side” of the coin handling apparatus.

(General Configuration of Coin Handling Apparatus)

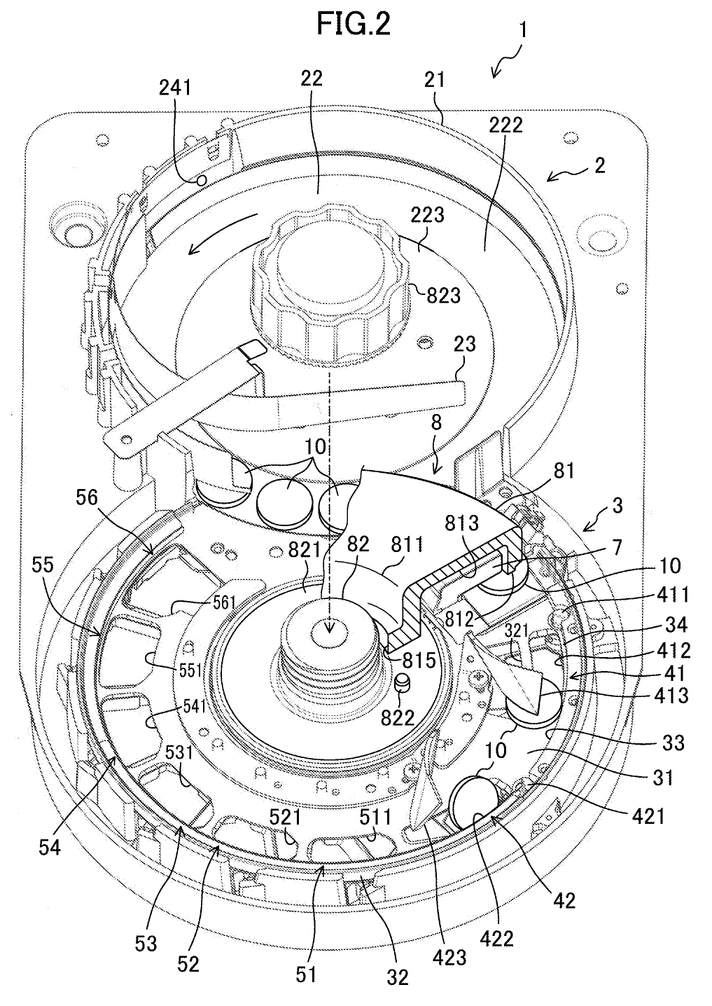

FIG. 2 illustrates an internal configuration for the coin handling apparatus 1. The coin handling apparatus 1 includes a feeding unit 2 disposed on the rear side thereof and a handling unit 3 disposed on the front side thereof. Inside the coin handling apparatus 1, the feeding and handling units 2 and 3 that are integrated together generally have an “8” shape when these units are viewed from above.

As illustrated in FIG. 1, the coin handling apparatus 1 includes an inlet 11 in which coins are dropped. The inlet 11 is opened upward in a rear portion of the upper surface of the coin handling apparatus 1. The inlet 11 is connected to the feeding unit 2. The coins dropped into the inlet 11 enter the feeding unit 2. The feeding unit 2 is configured to feed the coins one by one to the handling unit 3. Although not shown, a hopper may be attached to the coin handling apparatus 1. The hopper may be configured to have functions of storing coins and automatically sending the coins to the feeding unit 2.

A display 12 as a display unit and an operating unit 13 are provided on a front portion of the upper surface of the coin handling apparatus 1.

The coin handling apparatus 1 has a plurality of drawers 6. The drawers 6 are arranged side by side along a front arcuate portion of the coin handling apparatus 1. Each of the drawers 6 is attachable to and detachable from the coin handling apparatus 1. As will be described later, each of the drawers 6 is connected to first or second driving sorting unit 41 or 42, or an associated one of first to sixth diameter-sorting units 51 to 56 of the handling unit 3.

(Configuration of Handling Unit)

The handling unit 3 sorts coins 10 according to their denominations. The exemplary coin handling apparatus 1 illustrated on the drawings is able to sort out United States 1 cent coins (pennies), 5 cent coins (nickels), 10 cent coins (dimes), 25 cent coins (quarters), 50 cent coins, and 1 dollar coins from each other. Further, the handling unit 3 is able to sort out counterfeit coins and unfit coins (i.e., reject these coins). Note that the coin handling apparatus 1 is not used only for sorting the US coins, but may also be used for sorting coins of other countries.

In a configuration example of the coin handling apparatus 1 disclosed herein, the handling unit 3 includes a coin track 31, a recognition unit 7, two driving sorting units, namely, first and second driving sorting units 41 and 42, and six diameter-sorting units, namely, first to sixth diameter-sorting units 51 to 56, which collectively serve as a sorting unit, and a transport unit 8. Note that the number of the driving sorting units is not limited to two. The number of the driving sorting units may be one, or may be three or more. Furthermore, the driving sorting units may be omitted. The number of the diameter-sorting units is not limited to six. The number of the diameter-sorting units can be appropriately set, for example, in accordance with the currency (in other words, the number of coin denominations) of a country in which the coin handling apparatus 1 is used.

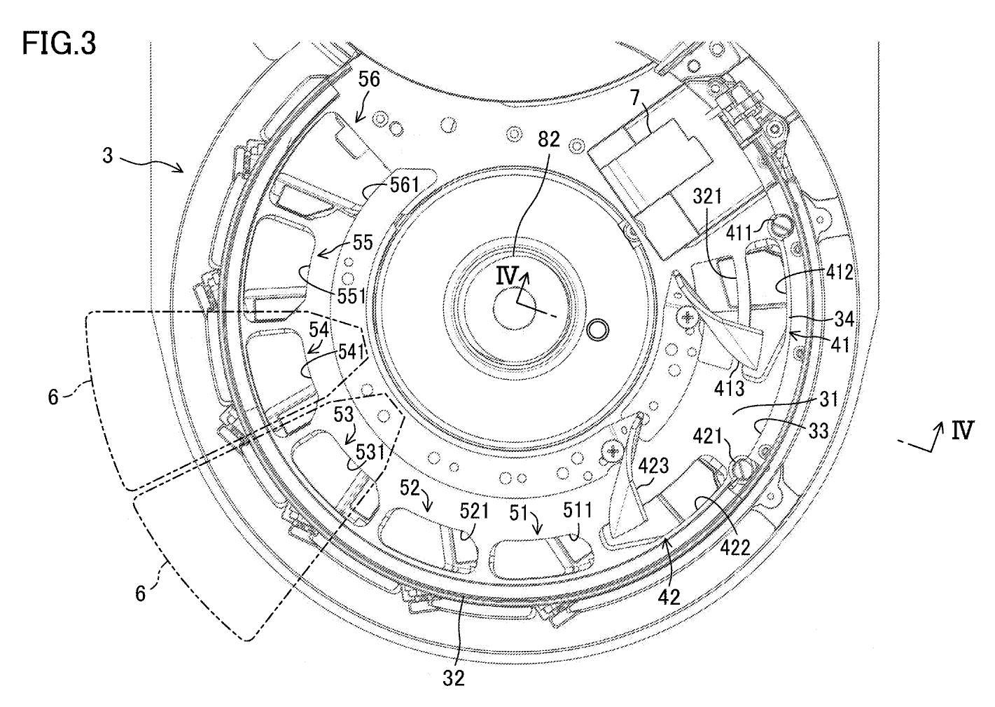

FIG. 3 shows the handling unit 3 as viewed from above. The handling unit 3 includes a base member 32. The coin track 31 is provided on an upper surface of the base member 32. The coin track 31 is a passage through which the coins travel. The coin track 31 is an arcuate track extending along an outer peripheral edge of the base member 32 having a substantially disklike shape. The coin track 31 has a width larger than the maximum width of the diameters of the coins 10 to be handled by the coin handling apparatus 1. An upstream end of the coin track 31 is an upper portion of FIG. 3. At the upstream end, the coin track 31 receives the coins 10 from the feeding unit 2 described later. The coins 10 travel in the clockwise direction in FIG. 3 along the coin track 31. A downstream end of the coin track 31 is an upper left portion of FIG. 3.

The coin track 31 has an arcuate reference edge 33 at an outer peripheral edge of the base member 32. The arcuate reference edge 33 curves around the coin track 31. The arcuate reference edge 33 regulates an outer peripheral edge of the coin 10 traveling along the coin track 31.

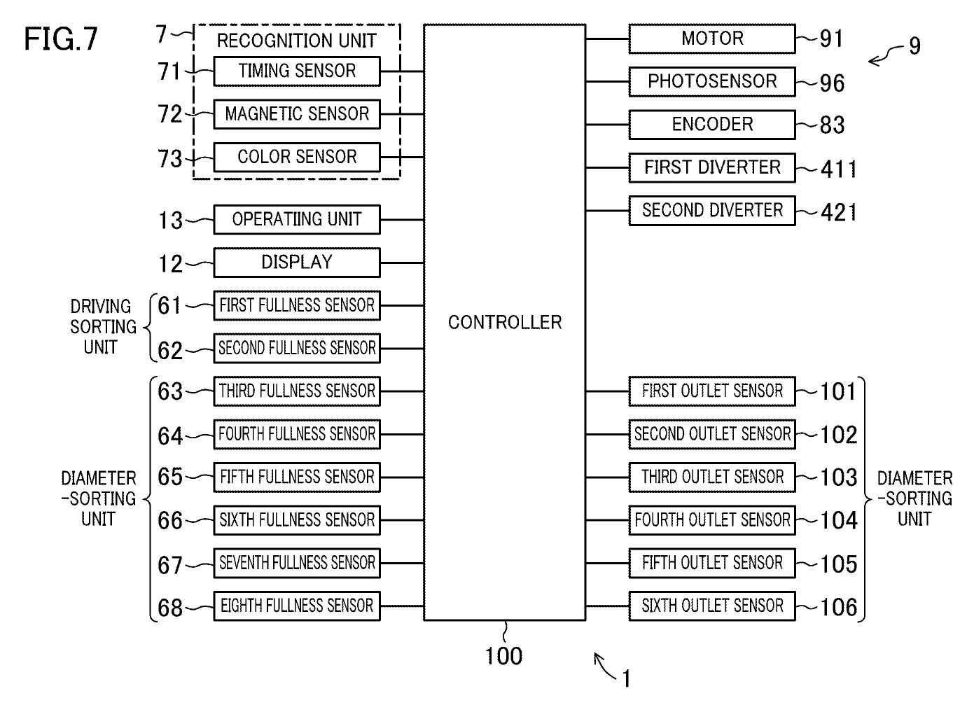

The recognition unit 7 recognizes each of the coins 10 passing through the recognition unit 7. The recognition unit 7 is disposed upstream of the coin track 31. The recognition unit 7 includes, as shown in FIG. 7, a timing sensor 71, a magnetic sensor 72, and a color sensor 73. Although not illustrated in detail, the magnetic and color sensors 72 and 73 are located downstream of the timing sensor 71. The timing sensor 71 senses the passage of the coins 10. The magnetic and color sensors 72 and 73 start sensing in response to the sensing of the passage of the coin 10 by the timing sensor 71. The magnetic sensor 72 senses magnetic property of each coin 10. The color sensor 73 senses the color of the surface of each coin 10. Based on the sensing results obtained by these sensors 72 and 73, the recognition unit 7 determines at least the denomination, authenticity, or fitness of each coin 10.

Note that, if the coin handling apparatus 1 has no driving sorting unit, the recognition unit 7 can be omitted.

The first and second driving sorting units 41 and 42 sort the coins 10 based on the recognition results of the recognition unit 7. The first and second driving sorting units 41 and 42 are arranged along the coin track 31. The first driving sorting unit 41 is arranged downstream of the recognition unit 7. The second driving sorting unit 42 is arranged downstream of the first driving sorting unit 41. Coins 10 that are not received by the first and second driving sorting units 41 and 42, e.g., genuine and fit coins, pass through the first and second driving sorting units 41 and 42.

The first and second driving sorting units have substantially the same configuration. Now, the configuration of the first driving sorting unit 41 will be described below, and the description of the configuration of the second driving sorting unit 42 is omitted.

The first driving sorting unit 41 includes a first diverter 411. The first diverter 411 operates to selectively move the coins 10 traveling along the coin track 31 away from the arcuate reference edge 33. The first diverter 411 has a shaft having a semicircular cross section. The shaft is arranged along the arcuate reference edge 33. The shaft is rotatable. When the shaft rotates, the shaft having the semicircular cross section projects into the coin track 31 as illustrated in FIG. 3. The coins 10 traveling along the coin track 31 collide against the shaft to move in a direction away from the arcuate reference edge 33. The first diverter 411 rotates the shaft in response to a drive signal from a controller 100 to be described later.

The first driving sorting unit 41 has a first opening 412. The first opening 412 is cut through the base member 32. The first opening 412 penetrates the base member 32. The first opening 412 is disposed downstream of the first diverter 411. The first opening 412 receives the coins 10 which have been moved by the first diverter 411 in the direction away from the arcuate reference edge 33.

In the base member 32, a narrow rail portion 34 is provided between the first opening 412 and the arcuate reference edge 33. The first opening 412 is arranged at an interval from the arcuate reference edge 33 in a radially inward direction. The rail portion 34 extends along the arcuate reference edge 33 from the upstream to downstream ends of the coin track 31. The first opening 412 has a radial width smaller than the minimum width of the diameters of the coins 10 to be handled by the coin handling apparatus 1. The first opening 412 may have a predetermined width in the circumferential direction. The coin 10 that is going to pass through the first driving sorting unit 41 passes over the first opening 412 with its edge traveling over the rail portion 34 as shown in FIG. 2. The coin 10 that is going to be received by the first driving sorting unit 41 is moved by the first diverter 411 in the direction away from the arcuate reference edge 33. Thus, the edge of the coin leaves the rail portion 34 to overhang the first opening 412. Then, the coin 10 inclines over the first opening 412 to fall into the first opening 412. The drawers 6 are attached under the base member 32. The coin that has fallen into the first opening 412 enters an associated one of the drawers 6. Note that the example shown in FIG. 2 illustrates how the coin 10 that has inclined falls into a second opening 422 to be described later.

The first opening 412 has upper and lower opening edges on the upper and lower surfaces of the base member 32, respectively, which are located at different positions and have different shapes. The upper opening edge of the first opening 412 on the upper surface of the base member 32 is positioned and shaped appropriately to receive the coins 10 from the coin track 31. The lower opening edge of the sorting opening 412 on the lower surface of the base member 32 has a position and a shape corresponding to those of an associated one of the drawers 6.

The first driving sorting unit 41 includes a first deflector 413. The first deflector 413 is arranged downstream of the first opening 412. The first deflector 413 is disposed over the first opening 412 to leave an interval that allows the coins 10 to pass through, and is positioned to make contact with a tipped up edge of each of the coins 10. The coins 10 passing through the first driving sorting unit 41 travel under the first deflector 413. The coins 10 to be received by the first driving sorting unit 41 hit the first deflector 413 by their tipped up edges, and are deflected into the first opening 412. Regardless of their size, the coins 10 surely fall into the first opening 412.

As illustrated in FIG. 3, the second driving sorting unit 42 includes a second diverter 421, a second opening 422, and a second deflector 423. An upper opening edge of the second opening 422 on the upper surface of the base member 32 is positioned and shaped appropriately to receive the coins 10 from the coin track 31. A lower opening edge of the second opening 422 on the lower surface of the base member 32 has a position and a shape corresponding to those of an associated one of the drawers 6. The upper and lower opening edges of the second opening 422 on the upper and lower surfaces of the base member 32 are located at different positions and have different shapes. The first and second openings 412 and 422 have the same shape.

The interval between the first opening 412 of the first driving sorting unit 41 and the second opening 422 of the second driving sorting unit 42 is larger than the interval between adjacent ones of openings 511, 521, 531, 541, 551, and 561 of the diameter-sorting units 51 to 56 to be described later.

The first and second driving sorting units 41 and 42 actively sort the coins 10 by driving the first and second diverters 411 and 421. Thus, these driving sorting units 41 and 42 may be called “active sorting units.”

The first to sixth diameter-sorting units 51 to 56 sort the coins 10 according to the difference in diameter among the coins 10. The first to sixth diameter-sorting units 51 to 56 are arranged along the coin track 31. The first to sixth diameter-sorting units 51 to 56 are disposed downstream of the second driving sorting unit 42. The first to sixth diameter-sorting units 51 to 56 are arranged in this order from upstream to downstream of the coin track 31. The sixth diameter-sorting unit 56 is arranged at the downstream end of the coin track 31.

The diameter-sorting units 51 to 56 have openings 511, 521, 531,541, 551, and 561, respectively. The openings 511, 521, 531,541, 551, and 561 are cut through the base member 32. The openings 511, 521, 531,541, 551, and 561 penetrate the base member 32. The rail portion 34 is provided between the openings 511, 521, 531,541, 551, and 561 and the arcuate reference edge 33. Just like the first and second openings 412 and 422 of the first and second driving sorting units 41 and 42, each of the openings 511, 521, 531, 541, 551, and 561 of the diameter-sorting units 51 to 56 also has upper and lower opening edges on the upper and lower surfaces of the base member 32, which are located at different positions and have different shapes. The upper opening edge of each of the openings 511, 521, 531, 541, 551, and 561 on the upper surface of the base member 32 is positioned and shaped appropriately to receive the coins 10 from the coin track 31. The lower opening edge of each of the openings 511, 521, 531, 541, 551, and 561 on the lower surface of the base member 32 has a position and a shape corresponding to those of an associated one of the drawers 6.

The openings 511, 521, 531,541, 551, and 561 of the diameter-sorting units 51 to 56 have mutually different radial widths. The opening 511 of the first diameter-sorting unit 51 has the narrowest radial width, while the opening 561 of the sixth diameter-sorting unit 56 has the widest radial width. The radial width of the openings 511, 521, 531, 541, 551, and 561 gradually increases in the order from the first diameter-sorting unit 51 to the sixth diameter-sorting unit 56. Each of the openings 511, 521, 531,541, 551, and 561 is configured to receive coins of diameters smaller than a predetermined size.

The width of the opening 511 of the first diameter-sorting unit 51 corresponds to the minimum width of the diameters of the coins 10 to be handled by the coin handling apparatus 1. In the exemplary coin handling apparatus 1 illustrated on the drawings, the width of the opening 511 of the first diameter-sorting unit 51 corresponds to the diameter of 10 cent coins. The first diameter-sorting unit 51 receives 10 cent coins. Coins 10 larger in diameter than 10 cent coins pass on through the first diameter-sorting unit 51.

The width of the opening 521 of the second diameter-sorting unit 52 corresponds to the diameter of 1 cent coins, and thus the second diameter-sorting unit 52 receives 1 cent coins. Coins 10 larger in diameter than 1 cent coins pass on through the second diameter-sorting unit 52.

The width of the opening 531 of the third diameter-sorting unit 53 corresponds to the diameter of 5 cent coins, and thus the third diameter-sorting unit 53 receives 5 cent coins. Coins 10 larger in diameter than 5 cent coins pass on through the third diameter-sorting unit 53.

The width of the opening 541 of the fourth diameter-sorting unit 54 corresponds to the diameter of 25 cent coins, and thus the fourth diameter-sorting unit 54 receives 25 cent coins. Coins 10 larger in diameter than 25 cent coins pass on through the fourth diameter-sorting unit 54.

The width of the opening 551 of the fifth diameter-sorting unit 55 corresponds to the diameter of 1 dollar coins, and thus the fifth diameter-sorting unit 55 receives 1 dollar coins. Coins 10 larger in diameter than 1 dollar coins pass on through the fifth diameter-sorting unit 55.

The width of the widest opening 561 of the sixth diameter-sorting unit 56 corresponds to the diameter of 50 cent coins. The sixth diameter-sorting unit 56 receives 50 cent coins, and is able to receive all the coins 10 that have reached the sixth diameter-sorting unit 56.

The openings 511, 521, 531,541, 551, and 561 of the diameter-sorting units 51 to 56 have substantially the same width in the circumferential direction. The circumferential width of the openings 511, 521, 531,541, 551, and 561 of the diameter-sorting units 51 to 56 is smaller than the circumferential width of the first and second openings 412 and 422 of the first and second driving sorting units 41 and 42.

As their portions are illustrated in phantom in FIG. 3, the drawers 6 are attached respectively to the first to sixth diameter-sorting units 51 to 56 under the base member 32. The coins that have fallen through each of the openings 511, 521, 531, 541, 551, and 561 are accumulated in an associated one of the drawers 6.

The first to sixth diameter-sorting units 51 to 56 do not include any driving member such as the first and second diverters 411 and 421 of the first and second driving sorting units 41 and 42. The first to sixth diameter-sorting units 51 to 56 may be called “passive sorting units” because they passively sort the coins 10.

The base member 32 is provided with a removal opening 321 configured to remove foreign matters. The removal opening 321 is located radially inside the first opening 412 of the first driving sorting unit 41. The removal opening 321 penetrates the base member 32. Foreign matters that follow the coins 10 traveling along the coin track 31 are removed from the coin track 31 through the removal opening 321.

The transport unit 8 includes a transport disk 81. The transport disk 81 moves the coins 10 along the coin track 31. Although only partially illustrated in FIG. 2, the transport disk 81 is arranged over the base member 32 to cover the coin track 31. The transport disk 81 is attached to a rotating shaft 82 arranged at the center of the handling unit 3, and rotates together with the rotating shaft 82 in the clockwise direction in FIG. 2.

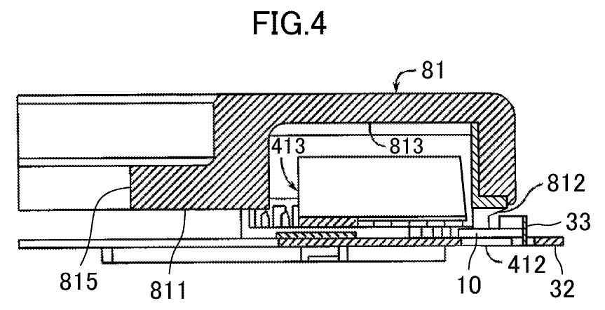

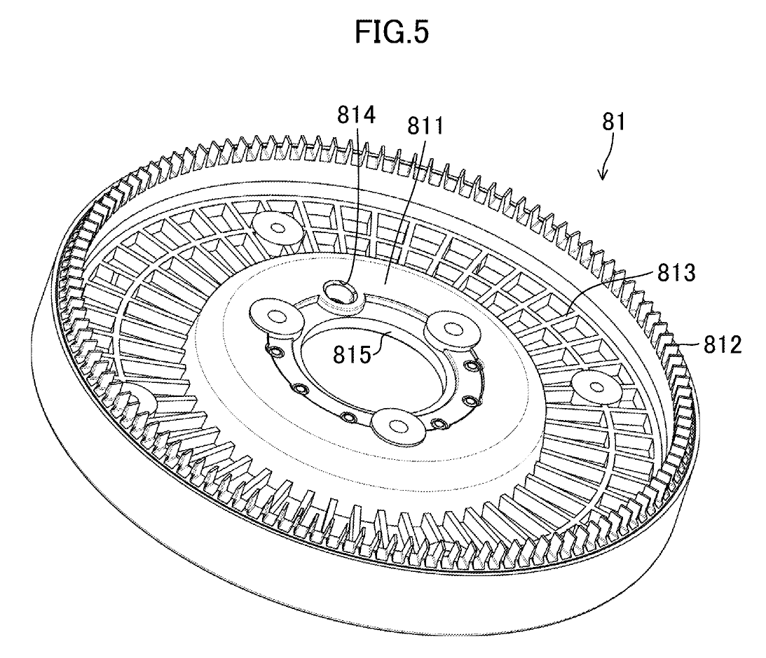

As illustrated in FIG. 4 and FIG. 5, the transport disk 81 includes a hub 811 attached to the rotating shaft 82, multiple fins 812 provided along an outer circumferential edge of the transport disk 81, and a recess 813 between the hub 811 and the fins 812.

The multiple fins 812 are provided on the lower surface of the transport disk 81. The fins 812 extend downward and are arranged in the circumferential direction along the outer peripheral edge of the transport disk 81. The fins 812 are elastic members made of polyurethane, for example. A distance between the bottom of the fins 812 and a surface of the coin track 31 on which the coin slides is smaller than the thickness of the coin 10 and is larger than zero. The fins 812 contact with the upper surface of the coin 10 to press the coin 10 downward.

As illustrated in FIG. 2 and FIG. 4, the recess 813 of the transport disk 81 is provided to face the recognition unit 7 and the first and second deflectors 413 and 423 of the first and second driving sorting units 41 and 42. The transport disk 81 rotates without interfering with any of the recognition unit 7 and the first and second deflectors 413 and 423.

The transport disk 81 rotates while pressing the coins 10 downward with the fins 812, thereby moving the coins 10 along the coin track 31.

In the first or second driving sorting unit 41 or 42, the coin 10 moved by the first or second diverter 411 or 421 in the direction away from the arcuate reference edge 33 is pressed by the transport disk 81. Thus, the coin 10 inclines with reliability in the first or second opening 412 or 422, and then falls into the first or second opening 412 or 422 with reliability.

Likewise, in each of the first to sixth diameter-sorting units 51 to 56, if the sum of the radial width of the opening 511, 521, 531,541, 551, or 561 and the width of the rail portion 34 between the arcuate reference edge 33 and the opening is larger than the diameter of the coin 10, the coin 10 pressed by the transport disk 81 falls into the opening 511, 521, 531,541, 551, or 561 with reliability.

As illustrated in FIG. 5, a through hole 815 is formed in the hub 811 of the transport disk 81. The rotating shaft 82 is inserted in the through hole 815.

As illustrated in FIG. 2, the rotating shaft 82 has a flange 821. When the rotating shaft 82 is inserted in the through hole 815 of the transport disk 81, a lower surface of the hub 811 comes into contact with an upper surface of the flange 821. The flange 821 has a pin 822 protruding upward. As illustrated in FIG. 5, the hub 811 of the transport disk 81 has a pin hole 814 formed in the lower surface of the hub 811. The pin 822 is inserted into the pin hole 814.

As illustrated in an exploded view in FIG. 2, a cap 823 is attached to the rotating shaft 82. Specifically, with the rotating shaft 82 inserted into the through hole 815 of the transport disk 81 and the pin 822 of the flange 821 inserted into the pin hole 814, the cap 823 is fastened to the rotating shaft 82 (see a dash-dot line arrow in FIG. 2). Thus, the transport disk 81 is fixed to the rotating shaft 82. Since the pin 822 and the pin hole 814 engage with each other, the transport disk 81 rotates together with the rotating shaft 82 without rattling.

As will be described later, when a transport error, such as jamming of the coin 10, occurs on the coin track 31, the transport disk 81 is detached from the coin handling apparatus 1 for recovery from the transport error. An operator of the coin handling apparatus 1 opens a top cover of a casing of the coin handling apparatus 1 to expose the handling unit 3, and loosens the cap 823 to remove the cap 823 from the rotating shaft 82. Subsequently, the operator lifts the transport disk 81 upward to pull the transport disk 81 out of the rotating shaft 82. Thus, the transport disk 81 is detached from the coin handling apparatus 1, which exposes the coin track 31.

(Configuration of Feeding Unit)

As illustrated in FIG. 2, the feeding unit 2 has a partition wall 21 arranged in an approximately circumferential form. The coins 10 are temporarily held inside the feeding unit 2 surrounded by the partition wall 21. At a portion with no partition wall 21, that is, around the center in the front-rear direction of the coin handling apparatus 1, the feeding unit 2 and the handling unit 3 are coupled to each other.

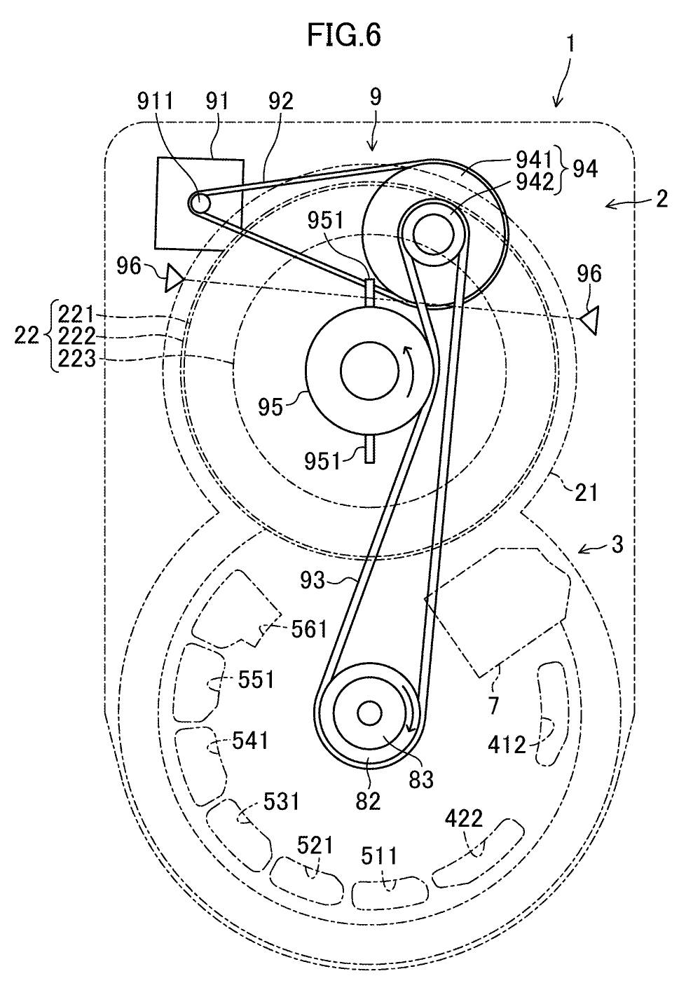

As illustrated in FIG. 2, the feeding unit 2 includes the rotating plate 22. The coin 10 is placed on the rotating plate 22. The rotating plate 22 is configured to rotate about the rotating shaft extending in a vertical direction. The rotating plate 22 has a round shape and spreads to the vicinity of the partition wall 21. The rotating plate 22 includes a base 221 illustrated only in FIG. 6, a large diameter plate 222 attached to an upper side of the base 221; and a small diameter plate 223 attached to an upper surface of the large diameter plate 222. The radius of the large diameter plate 222 is larger approximately by the diameter of the coin 10 than the radius of the small diameter plate 223. A level difference is formed between the large diameter plate 222 and the small diameter plate 223. Although details will be described later, a second pulley 95 of a driving unit 9 described later is attached to the base 221. The base 221, large diameter plate 222, and small diameter plate 223 of the rotating plate 22 integrally rotate in the counterclockwise direction in FIG. 2.

When the rotating plate 22 rotates in the counterclockwise direction as indicated by an arrow in FIG. 2, the coin 10 on the rotating plate 22 is transported in the circumferential direction while being sent radially outward by a centrifugal force. The coin 10 dropped in the inlet 11 is placed on the rotating plate 22 at a rear portion of the feeding unit 2. The coin 10 is transported to a front portion of the feeding unit 2 as the rotating plate 22 rotates.

The feeding unit 2 includes a flat spring 23. The flat spring 23 is arranged near a portion at which the feeding unit 2 and the handling unit 3 are coupled to each other. The flat spring 23 roughly restricts the transport of the coins 10 by the rotating plate 22 so that the coins 10 are fed one by one into the coin track 31 from the feeding unit 2. The flat spring 23 has a base end fixed to the partition wall 21, and is arranged to extend toward the inside of the feeding unit 2 to be elastically deformable.

The flat spring 23 is arranged to keep a predetermined distance from the upper surface of the rotating plate 22. Among the coins 10 traveling on the rotating plate 22 with the rotation of the rotating plate 22, several layers of coins 10 in contact with, or vertically close to, the rotating plate 22 pass below the flat spring 23, and are moved subsequently radially outward by a centrifugal force. In other words, even when the coins 10 are piled up inside the feeding unit 2, several layers of coins 10 that have passed below the flat spring 23 are released from the gravity of the coins 10 restricted by the flat spring 23, and travel radially outward by the centrifugal force. Thus, the coins 10 are divided into coins 10 in direct contact with the large diameter plate 222 and coins 10 on the former coins 10.

When viewed from above, the outer peripheral edge of the large diameter plate 222 and the outer peripheral edge of the transport disk 81 overlap each other in the radial direction at the portion at which the feeding unit 2 and the handling unit 3 are coupled to each other. The coin 10 in the lowermost layer which is in direct contact with the large diameter plate 222 is pressed from above in the thickness direction of the coin 10 by the fins 812 of the transport disk 81, with its motion being restricted by the contact with an end face of the small diameter plate 223. After that, the transport disk 81 causes the coin 10 pressed from above by the fins 812 to travel along the coin track 31 of the handling unit 3.

In contrast, the coins 10 which are not in direct contact with the large diameter plate 222, i.e., which are not in the lowermost layer, do not make contact with the end face of the small diameter plate 223. Therefore, the coins 10 are pushed back toward the feeding unit 2 by the fins 812 of the transport disk 81, and are kept transported by the rotating plate 22.

Thus, as illustrated in FIG. 2, the flat spring 23 and the rotation of the rotating plate 22 and the transport disk 81 cause the plurality of layers of coins 10 to be arranged in a single layer and a single file in the circumferential direction at the portion at which the feeding unit 2 and the handling unit 3 are coupled to each other.

A feeding error in the feeding unit 2, which will be described later, easily occurs near the flat spring 23 to which piled coins 10 are sent, or near the portion at which the feeding unit 2 and the handling unit 3 are coupled to each other.

(Drive Configuration)

FIG. 6 is a top view illustrating the transport disk 81 of the handling unit 3 (that is, the rotating shaft 82 to which the transport disk 81 is attached) and the driving unit 9 configured to rotate the rotating plate 22 of the feeding unit 2. The driving unit 9 is configured to rotate the transport disk 81 and the rotating plate 22 with a single motor 91. Use of the single motor 91 makes it possible to downsize the coin handling apparatus 1 and simplify the structure of the coin handling apparatus 1.

The motor 91, the rotating shaft 82, and the rotating plate 22 are coupled together by first and second belts 92 and 93. The first belt 92 and the second belt 93 are, for example, V-ribbed belts.

Specifically, the first belt 92 is wound around a shaft 911 of the motor 91 and a first pulley 94. The first pulley 94 includes a large pulley 941 and a small pulley 942, and the first belt 92 is wound around the large pulley 941. The large pulley 941 and the small pulley 942 are coaxially arranged and integrated together. The first belt 92 may be omitted and the motor 91 may directly rotate the first pulley.

The second belt 93 is wound around the small pulley 942 of the first pulley 94 and the rotating shaft 82.

A second pulley 95 is provided for the base 221 of the rotating plate 22. The rotating plate 22 and the second pulley 95 integrally rotate. The second pulley 95 is in contact with a back surface of the second belt 93 between the rotating shaft 82 and the first pulley 94.

When the shaft 911 of the motor 91 rotates, a rotary force of the motor 91 is transmitted to the rotating shaft 82 via the first belt 92, the second pulley 95, and the second belt 93, so that the rotating shaft 82 rotates in the clockwise direction in FIG. 6 (see an arrow). Thus, the transport disk 81, not illustrated in FIG. 6, rotates in the clockwise direction. With the running of the second belt 93, the second pulley 95 rotates in the counterclockwise direction in FIG. 6 (see an arrow). Thus, the rotating plate 22 of the feeding unit 2 rotates in the counterclockwise direction. In this way, the driving unit 9 is configured such that the single motor 91 allows the transport disk 81 and the rotating plate 22 to rotate in opposite directions.

The driving unit 9 includes a (rotary) encoder 83 configured to detect an angle of rotation of the transport disk 81 and serves as a rotational angle detector, and a photosensor 96 configured to detect the rotational speed of the rotating plate 22 and serves as a rotational speed detector. The encoder 83 is attached to the rotating shaft 82, and outputs a pulse signal (that is, an encoder pulse) at every predetermined angle of rotation when the rotating shaft 82 and the transport disk 81 rotate. The photosensor 96 includes a light emitting element and a light receiving element. The photosensor 96 indicated by a dash-dot-dot line in FIG. 6 is arranged so that its optical axis extends in a direction traversing the rotating plate 22 in the vicinity of the second pulley 95. The second pulley 95 is provided with two ribs (that is, projections) 951 protruding radially outward and are spaced from each other at an angle of 180°. When the second pulley 95 rotates, each of the ribs 951 periodically interrupts the optical axis of the photosensor 96. The photosensor 96 outputs a detection signal in accordance with the transmission and blocking of light. In accordance with the detection signal from the photosensor 96, the rotational speed of the second pulley 95, that is, the rotational speed of the rotating plate 22, can be detected.

(Configuration for Control of Coin Handling Apparatus)

FIG. 7 is a block diagram illustrating a configuration of the coin handling apparatus 1. The coin handling apparatus 1 includes a controller 100. The controller 100 is an example of a control unit. The controller 100 is coupled to the feeding unit 2, the recognition unit 7, the transport unit 8, the driving unit 9, and the first and second diverters 411 and 421 of the first and second driving sorting units 41 and 42 so that the controller 100 is able to transmit and receive signals to and from these units and diverters.

The controller 100 is also coupled to the display 12 and the operating unit 13. The display 12 displays various types of information. The display 12 may be configured as a touch panel display. The touch panel display 12 allows the user to perform various kinds of operations on an on-screen image on the display. The operating unit 13 functions as an interface between the user (i.e., the operator) and this coin handling apparatus 1.

The first to sixth diameter-sorting units 51 to 56 are provided with first to sixth outlet sensors 101 to 106, respectively. The first to sixth outlet sensors 101 to 106 are each an example of a fall detector. The first to sixth outlet sensors 101 to 106 are connected to the controller 100 so that they are able to transmit and receive signals to and from the controller 100. Note that, in this configuration example, the first and second driving sorting units 41 and 42 are provided with no outlet sensor, but the first and second driving sorting units 41 and 42 may be provided with outlet sensors, respectively.

Each of the first to sixth outlet sensors 101 to 106 detects that the coin 10 has fallen into an associated one of the openings 511, 521, 531, 541, 551, or 561. The first to sixth outlet sensors 101 to 106 may be photosensors, for example. That is, each of the first to sixth outlet sensors 101 to 106 detects whether an associated one of the first to sixth diameter-sorting units 51 to 56 has received the coin 10.

The encoder 83 attached to the rotating shaft 82 outputs an encoder pulse to the controller 100. The encoder 83 outputs a pulse signal in accordance with the angle of rotation of the transport disk 81. The controller 100 detects the angle and direction of rotation of the transport disk 81 based on the pulse signal from the encoder 83. The photosensor 96 provided for the feeding unit 2 outputs a detection signal to the controller 100. The controller 100 detects the rotational speed of the rotating plate 22 based on the detection signal from the photosensor 96.

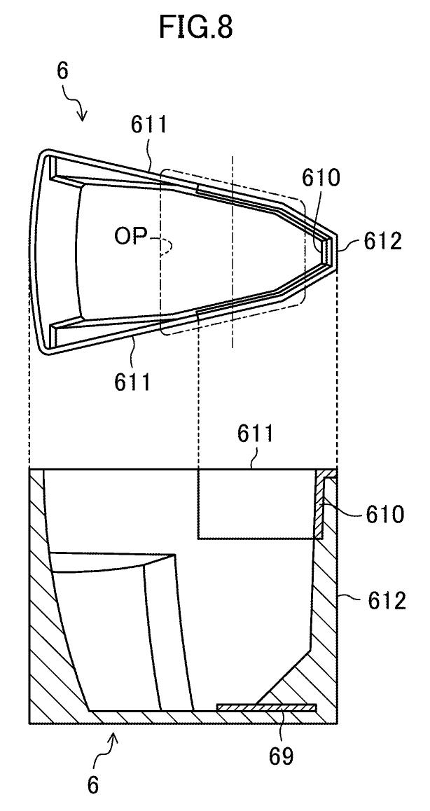

The first and second driving sorting units 41 and 42 and the first to sixth diameter-sorting units 51 to 56 are provided with first to eighth fullness sensors 61 to 68, each of which detects that an associated one of the drawers 6 is full of coins. As illustrated in FIG. 8, each of the fullness sensors 61 to 68 includes detection plates 69 and 610 respectively attached to the bottom and top of its associated drawer 6. When the drawer 6 is set in the coin handling apparatus 1, the detection plates 69 and 610 are independently electrically connected to the coin handling apparatus 1 (not shown). When the drawer 6 is full of coins, the two detection plates 69 and 610 become electrically conductive with each other through the coins. Each of the fullness sensors 61 to 68 detects that a corresponding one of the drawers 6 is full of the coins based on the electrical conductivity between the two detection plates 69 and 610. The first and second fullness sensors 61 and 62 are provided for the first and second driving sorting units 41 and 42, respectively. The third to eighth fullness sensors 63 to 68 are provided for the first to sixth diameter-sorting units 51 to 56, respectively.

Each of the fullness sensors 61 to 68 is configured to individually detect that the associated one of the drawers 6 is full. Alternatively, the fullness sensor may be attached to only one of the drawers 6, so that the fullness sensor may detect that all of the drawers 6 are full when the corresponding drawer 6 is full.

The controller 100 receives signals from the operating unit 13, the recognition unit 7, the encoder 83, the photosensor 96, the outlet sensors 101 to 106, and the fullness sensors 61 to 68, and drives the motor 91 of the driving unit 9 and the first and second diverters 411 and 421, thereby operating the coin handling apparatus 1. The controller 100 displays various kinds of information on the display 12.

(Configuration of Drawer)

The configuration of the drawers 6 will be described in more detail below with reference to FIG. 8. As described above, the drawers 6 are arranged side by side along an arc. When viewed from above, each of the drawers 6 is in the shape of a fan. The drawer 6 has a base end portion (that is, a right end portion on the paper of FIG. 8) in which a distance between two vertical walls 611 is small, and a tip end portion (that is, a left end portion on the paper of FIG. 8) in which the distance between the two vertical walls 611 is large.

The detection plate 610 attached to the top of the drawer 6 is approximately V-shaped when viewed from above so as to be spread over three walls, namely, the two vertical walls 611 and a vertical wall 612 between the vertical walls 611 at the base end portion of the drawer 6. The detection plate 610 extends toward the tip end of the drawer 6 along the vertical walls 611. The tip end of the detection plate 610 is located closer to the tip end of the drawer 6 than the center of an opening OP (indicated by a dash-dot line in FIG. 8) which is cut through the base member 32 and into which the coin 10 falls. Furthermore, as illustrated at the bottom of FIG. 8, the detection plate 610 extends downward from the opening at the top of the drawer 6 along an inner wall of the drawer 6. The drawer 6, which receives the coin 10 fallen into the opening OP, is made of a rubber material to reduce a sound generated when the coin 10 falls. The detection plate 610 is attached to the drawer 6 to be embedded in the vertical walls 611 and 612 made of a rubber material.

Since the drawer 6 is attached to or detached from the coin handling apparatus 1, an electrode constituting the fullness sensor may be attached to the coin handling apparatus 1, and the drawer 6 may be configured to abut on the electrode when attached to the coin handling apparatus 1. However, in this case, when the drawer 6 is attached or detached, the electrode making contact with the drawer 6 may be deformed, which may deteriorate the detection accuracy of the fullness sensor. However, with the detection plate 610 attached to the inner wall of the drawer 6, the detection plate 610 is not deformed through the attachment and detachment of the drawer 6 to and from the coin handling apparatus 1. This can keep the high detection accuracy of the fullness sensor.

Further, since the detection plate 610 attached to the drawer 6 spreads over the three walls at the base end portion of the drawer 6, the coins 10, piled up in the base end portion of the drawer 6, can make contact with the detection plate 610 with reliability. Thus, it can be detected with high accuracy that the drawer 6 is full.

In addition, since the distance between the vertical walls 611 is small at the base end portion of the drawer 6, the coins 10 having a large diameter are piled up at a portion closer to the center of the drawer 6 than the base end portion. With the detection plate 610 extending further toward the tip end of the drawer 6 than the center of the opening OP, the coins 10 piled up at the portion toward the center of the drawer 6 make contact with the detection plate 610. Thus, also in this case, it can be detected with high accuracy that the drawer 6 is full.

As described above, the detection plate 610 made of a conductive material is attached to the drawer 6 to spread over the three walls near the opening at the base end portion of the drawer 6 made of a rubber material. This can reinforce the drawer 6, and can keep the drawer 6 from being deformed. In addition, the detection plate 610 can effectively protect the drawer 6 from the deformation due to aged deterioration of the rubber material.

(Operation of Coin Handling Apparatus)

The operation of the coin handling apparatus 1 will be briefly described below.

First, before starting to use the coin handling apparatus 1, the types of coins to be sorted into the first and second driving sorting units 41 and 42 are determined. As described above, the first and second driving sorting units 41 and 42 actively sort the coins 10 based on the recognition results. Each of the first and second driving sorting units 41 and 42 may receive an arbitrary type of coins 10.

In the following description, an exemplary operation of the coin handling apparatus 1 will be described on the supposition that counterfeit coins and suspected coins are sorted out by the first driving sorting unit 41, and unfit coins are sorted out by the second driving sorting unit 42.

When the operator drops the coins 10 into the inlet 11 and operates the operating unit 13, the coin handling apparatus 1 starts the handling of the coins. The controller 100 allows the motor 91 to rotate. Thus, the rotating plate 22 of the feeding unit 2 rotates, and the feeding unit 2 feeds the coins 10 one by one to the handling unit 3. Since the transport disk 81 is simultaneously rotated, the coins 10 are moved by the transport disk 8 along the coin track 31 in a single layer and a single file.

The recognition unit 7 recognizes each of the coins 10. The controller 100 rotates the first diverter 411 so that the forged coins and the suspected coins are sorted out by the first driving sorting unit 41 based on the recognition results. That is, timing when each of the coins 10 selected based on the recognition results reaches the first diverter 411 after passing through the timing sensor 71 of the recognition unit 7 is estimated in accordance with the encoder pulse, and then the shaft is rotated at this timing. The coins 10 are moved in a direction away from the arcuate reference edge 33, and thus fall into the first opening 412 of the first driving sorting unit 41. The coins 10 then enter the drawer 6 attached to the first driving sorting unit 41.

Further, the controller 100 rotates the second diverter 421 so that the unfit coins are sorted out by the second driving sorting unit 42 based on the recognition results. In other words, timing when each of the coins 10 selected based on the recognition results reaches the second diverter 421 after passing through the timing sensor 71 is estimated in accordance with the encoder pulse, and then the shaft is rotated at this timing. The coins 10 are moved in a direction away from the arcuate reference edge 33, and thus fall into the second opening 422 of the second driving sorting unit 42. The coins 10 then enter the drawer 6 attached to the second driving sorting unit 42.

Genuine and fit coins pass on through the first and second driving sorting units 41 and 42. Each of the coins 10 falls into, according to its diameter size, any one of the openings 511, 521, 531, 541, 551, and 561 of the first to sixth diameter-sorting units 51 to 56 and enters the drawer 6 attached to the one of the diameter-sorting units 51 to 56. Using the encoder pulse, the controller 100 tracks the position of the coins 10 that have passed through the recognition unit 7 and traveling along the coin track 31. Further, based the recognition results of the recognition unit 7, the detection results of the first to sixth outlet sensors 101 to 106, and the encoder pulse, the controller 100 may determine whether the coin 10 has fallen into an appropriate one of the openings 511, 521, 531, 541, 551, or 561. Specifically, in accordance with the position of the coin based on the encoder pulse and the detection results of the first to sixth outlet sensors 101 to 106, the opening into which the coin 10 has actually fallen can be identified. On the other hand, based on the recognition results of the recognition unit 7, the opening into which the coin 10 should fall is determined. By comparing the opening into which the coin 10 has actually fallen and the opening into which the coin 10 should fall, the controller 100 can determine whether the coin 10 has fallen into an appropriate one of the openings 511, 521, 531, 541, 551, or 561.

The first and second driving sorting units 41 and 42 have no outlet sensor. Thus, the controller 100 may monitor the change in the detection signals from the outlet sensors 101 to 106 of the first to sixth diameter-sorting units 51 to 56 to determine that the coins have been correctly sorted out by the first or second driving sorting unit 41 or 42 if no change in detection signals from these outlet sensors 101 to 106 is observed within a predetermined time.

The operator can drop the coins 10 into the inlet 11 at any time during the sorting by the coin handling apparatus 1. When all the coins 10 dropped into the inlet 11 are housed in any combination of the drawers 6, the coin handling apparatus 1 stops. The controller 100 presents, on the display 12, the total amount of the coins handled, for example. Alternatively, the controller 100 may also present on the display 12 the counts of the coins of different denominations on a denomination-by-denomination basis, for example.

(Control Performed when Error Occurs)

Next, control to be performed when an error has occurred during the sorting of the coins 10 by the coin handling apparatus 1 will be described below. The error mentioned herein includes a transport error caused by, for example, the jamming of the coins 10 on the coin track 31 of the handling unit 3, and a feeding error caused by, for example, the jamming of the coins 10 in the feeding unit 2.

When a transport error has occurred on the coin track 31, the controller 100 stops the coin handling apparatus 1. As described above, the operator opens the top cover of the coin handling apparatus 1 to expose the handling unit 3, and loosens the cap 823 to detach the cap 823 from the rotating shaft 82. Subsequently, the operator lifts the transport disk 81 upward to pull the transport disk 81 out of the rotating shaft 82. After exposing the coin track 31, the operator manually removes the coins 10 remaining on the coin track 31.

When the operator loosens the cap 823 or detaches the cap 823, the transport disk 81 may sometimes rotate together with the rotating shaft 82. Further, when the operator pulls the transport disk 81 out of the rotating shaft 82, the transport disk 81 may sometimes rotate together with the rotating shaft 82. As long as the pin 822 of the flange 821 is inserted into the pin hole 814, the transport disk 81 and the rotating shaft 82 integrally rotate.

When the transport disk 81 rotates during the error recovery operation, the coin 10 sandwiched between the transport disk 81 and the coin track 31 may be moved to fall into the opening of any one of the sorting units. If the operator does not notice that the coin has fallen during the recovery from the transport error and the coin remains in any one of the drawers 6, a count error may possibly occur.

Therefore, the coin handling apparatus 1 is configured such that, when a transport error has occurred on the coin track 31, the coin handling apparatus 1 is stopped, and then the position of the coin 10 on the coin track 31 is tracked while the operator performs the error recovery operation.

On the coin track 31, the coins, being pressed by the transport disk 81 from above, are moved in a single layer and a single file, and therefore, the transport error occurs with a relatively low frequency. If the transport error has occurred on the coin track 31, it is desirable that the coin handling apparatus 1 is stopped to suspend the handling by the coin handling apparatus 1, and the operator the error recovery operation in order to prevent erroneous sorting of the coins.

In contrast, the feeding error occurs more frequently than the transport error because the coins 10 overlap each other in the feeding unit 2. Thus, if the coin handling apparatus 1 is stopped every time the feeding error occurs, the coin handling apparatus 1 cannot smoothly execute the sorting. This leads to poor usability of the coin handling apparatus 1. As will be described later, the coin handling apparatus 1 can automatically recover from the feeding error in many cases. Thus, even when the feeding error occurs, it is desirable not to stop the coin handling apparatus 1.

However, the driving unit 9 of this coin handling apparatus 1 is configured to rotate both the transport disk 81 of the handling unit 3 and the rotating plate 22 of the feeding unit 2 with only one motor 91. For example, if error detection is performed based on a current value supplied to the motor 91 only, the occurrence of the transport error on the coin track 31 cannot be distinguished from the occurrence of the feeding error in the feeding unit 2. Hence, the coin handling apparatus 1 needs to be stopped also when the feeding error has occurred, just like when the transport error has occurred.

As a solution to this drawback, the coin handling apparatus 1 is configured such that the controller 100 compares the detection results of the encoder 83 and the detection results of the photosensor 96, so that the occurrence of the feeding error is detected in distinction from the occurrence of the transport error.

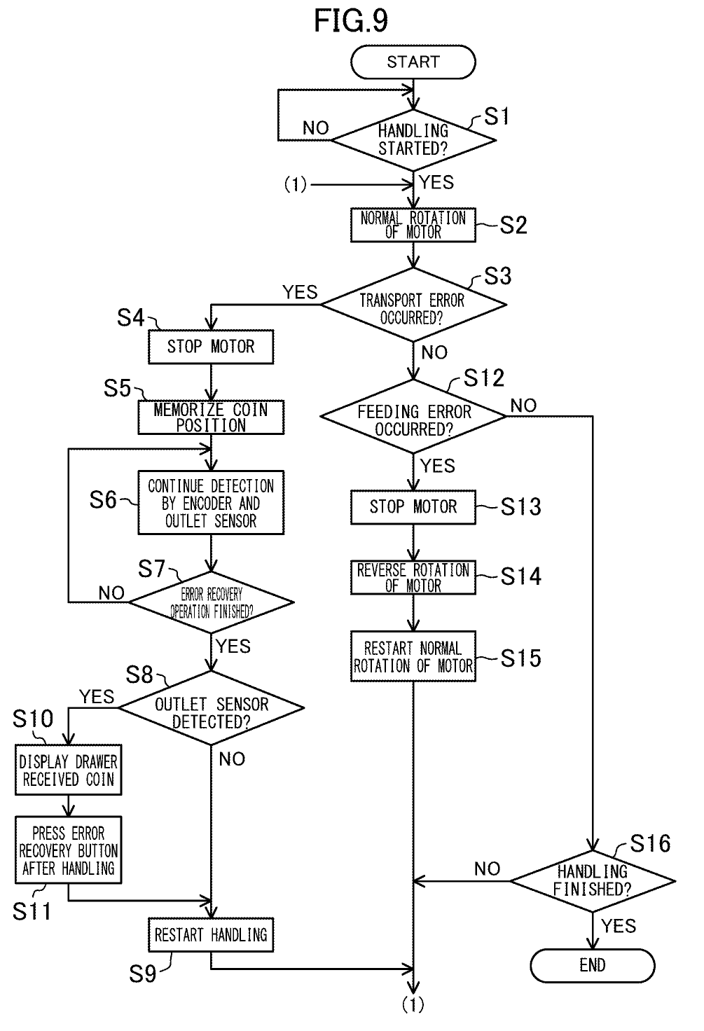

Next, control related to the recovery from the error executed by the controller 100 will be specifically described below with reference to a flowchart shown in FIG. 9. In Step S1 of the process in FIG. 9, the controller 100 determines whether the sorting of the coins 10 has been started. If the sorting has not been started, Step S1 is repeated. If the sorting has been started, the process proceeds to Step S2.

In Step S2, the controller 100 normally rotates the motor 91. Based on an encoder pulse outputted from the encoder 83, the controller 100 performs feedback control (PWM control) of controlling the pulse width of the current supplied to the motor 91 so that the transport disk 81 rotates at a predetermined rotational speed. Thus, the rotating plate 22 of the feeding unit 2 rotates, and the coins 10 are fed from the feeding unit 2 to the handling unit 3. Further, the transport disk 81 rotates to move the coins 10 in a single layer and a single file on the coin track 31 in the handling unit 3. Each of the coins 10 falls into any one of the openings 412, 422, 511, 521, 531,541, 551, or 561 of the first and second driving sorting units 41 and 42 and the first to sixth diameter-sorting units 51 to 56.

In Step S3, the controller 100 determines whether the transport error has occurred in the handling unit 3. The controller 100 may monitor the encoder pulse, the recognition results of the recognition unit 7, and the change in the detection signals from the outlet sensors 101 to 106 of the first to sixth diameter-sorting units 51 to 56, and determine that the transport error has occurred if any one of the detection signals from the outlet sensors 101 to 106 does not change when the change should occur. Alternatively, the determination may be made based on the value of the pulse width of the current supplied to the motor 91. In other words, if the value of the pulse width of the current supplied to the motor 91 exceeds a predetermined value, it may de determined that the transport disk 81 is not rotating, or is hardly rotating, and hence, the transport error has occurred. Alternatively, by detecting that the transport disk 81 is not rotating or hardly rotating based on the encoder pulse, the controller 100 may determine that the transport error has occurred. If it is determined that the transport error has occurred in Step S3, the process proceeds to Step S4. If it is determined that the transport error has not occurred in Step S3, the process proceeds to Step S12.

In Step S4, the controller 100 stops the motor 91. The handling of the coin handling apparatus 1 is suspended.

In subsequent Step S5, the controller 100 memorizes the position of the coin 10 on the coin track 31 when the motor 91 is stopped. As described above, based on the encoder pulse, the coin handling apparatus 1 tracks the position of the coin 10 that has passed through the recognition unit 7.

When the transport error has occurred, the operator performs the error recovery operation. Although only one motor 91 is used, the controller 100 can detect the occurrence of the transport error in distinction from the feeding error which will be described later. When the coin handling apparatus 1 is stopped due to the occurrence of the transport error, the controller 100 notifies the operator that the transport error has occurred via the display 12. As described above, the operator detaches the transport disk 81 from the coin handling apparatus 1, and manually removes the coin 10 from the coin track 31.

In Step S6, the controller 100 continues the detection by the encoder 83 and the outlet sensors 101 to 106. Therefore, also when the operator detaches the transport disk 81 after the stop of the motor 91, the controller 100 can detect whether the transport disk 81 has rotated at what angle and in which direction or the transport disk 81 has not rotated at all, and whether the coin has fallen into any of the openings.

As long as the pin 822 of the flange 821 engages with the pin hole 814 of the transport disk 81, the encoder 83 rotates when the transport disk 81 rotates. Thus, the angle of rotation of the transport disk 81 corresponds to the encoder pulse.

In Step S7, the controller 100 determines whether the operator has finished the error recovery operation, i.e., whether the operator has removed all the coins 10 from the coin track 31, slid the transport disk 81 onto the rotating shaft 82, fastened the cap 823 to attach the transport disk 81 to the coin handling apparatus 1, and then closed the top cover. If the answer in Step S7 is NO, the process returns to Step S6. If the answer in Step S7 is YES, the process proceeds to Step S8.

In Step S8, the controller 100 determines whether any of the outlet sensors 101 to 106 has detected the fall of the coin 10 during the error recovery operation. If the fall has been detected, the process proceeds to Step S10. If the fall has not been detected, the process proceeds to Step S9.

In Step S9, the handling being suspended can be resumed, and thus, the controller 100 resumes the handling. The process returns from Step S9 to Step S2, and the motor 91 normally rotates.

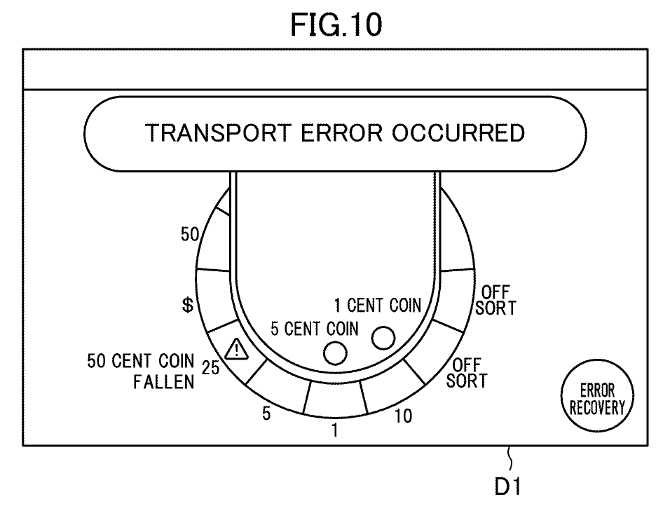

In Step S10, the operator is informed that the coin 10 entered the drawer 6 during the error recovery operation needs to be removed. For example, an on-screen image D1 illustrated in FIG. 10 is displayed on the display 12 of the coin handling apparatus 1. The on-screen image D1 indicates the drawer 6 into which the coin 10 has fallen. In the illustrated example, the on-screen image shows that the coin has fallen into the drawer 6 of the fourth diameter-sorting unit 54 that is configured to receive 25 cent coins. The on-screen image D1 also shows the denomination of the coin 10 fallen. In the illustrated example, the on-screen image shows that a 50 cent coin has fallen into the drawer 6 of the fourth diameter-sorting unit 54 that is configured to receive 25 cent coins.

In this example, although the denomination of the coin 10 fallen is displayed on the on-screen image D1, the information to be displayed is not necessarily the denomination as long as the information allows the operator to identify the coin 10 to be removed. For example, the on-screen image may show information about the currency of the coin 10, information indicating that the coin 10 is a counterfeit coin, or information indicating that the coin 10 is an unfit coin.

Based on the contents of the on-screen image D1, the operator can easily remove the coin 10 that has fallen during the error recovery operation from the drawer 6 into which the coin 10 has fallen.

Furthermore, the on-screen image illustrated in FIG. 10 also shows coins left on the coin track 31 during the recovery from the transport error after the stop of the motor 91. The example of FIG. 10 shows that a 5 cent coin and a 1 cent coin are remaining on the coin track 31. In the illustrated example, the on-screen image D1 roughly shows the positions of the 5 cent coin and the 1 cent coin on the coin track 31. The operator can determine whether all the coins that should be removed in the error recovery operation have been removed based on the coins manually removed from the coin track 31 in the error recovery operation and the information shown on the on-screen image D1. The on-screen image D1 shown in this manner allows the operator to precisely carry out the error recovery operation. After removing all the coins 10, the operator operates an “error recovered” button on the on-screen image D1 in FIG. 10 in Step S11, then the process proceeds from Step S11 to Step S9.

Although the on-screen image D1 is displayed after the error recovery operation is performed, the coin(s) remaining on the coin track 31 may be displayed on the screen after the motor 91 is stopped and before the error recovery operation is performed. This allows the operator to know how many coins need to be removed from the coin track 31 in the error recovery operation, or information of the coins such as the denomination. The operator can appropriately remove the coins from the coin track 31, which facilitates the error recovery operation.

In the above-described configuration, the on-screen image D1 is configured to display the drawer 6 into which the coin 10 has fallen and the information of the coin 10 such as the denomination. However, for example, when the coin 10 has entered an appropriate one of the drawers 6 (that is, the drawer 6 that the coin 10 should enter, e.g., the drawer 6 corresponding to the denomination of the coin 10), the amount of the coin 10 of the denomination is counted, and the on-screen image does not display the information that the coin 10 has fallen into the drawer 6, and only when the coin 10 has entered an inappropriate one of the drawers 6 (that is, the drawer 6 that the coin 10 should not enter, e.g., the drawer 6 which does not correspond to the denomination of the coin 10), the on-screen image may display the information that the coin 10 has fallen into the drawer 6. Further, when a plurality of coins has fallen, the number of coins and the information of the coins such as the denomination may be displayed together.

As described above, the movement of the coin 10, which can be detected based on the encoder pulse during the error recovery operation while the pin 822 of the flange 821 is engaged with the pin hole 814 of the transport disk 81 and the angle of rotation of the transport disk 81 corresponds to the encoder pulse, cannot be detected based on the encoder pulse once the pin 822 of the flange 821 is disengaged from the pin hole 814 of the transport disk 81. However, even if the detection is impossible, no problem arises because when the transport disk 81 is lifted to the extent that the pin 822 of the flange 821 is disengaged from the pin hole 814 of the transport disk 81, the fin 812 of the transport disk 81 no longer presses the coin 10, and the coin 10 does not move even when the transport disk 81 rotates, i.e., the detection of the movement of the coin 10 is no longer necessary.

Note that the above-described coin handling apparatus 1 includes the recognition unit 7, and is configured such that the first or second driving sorting unit 41 or 42 selectively sorts the coins 10 based on the recognition results of the recognition unit 7. As described above, the recognition unit 7 and the driving sorting units 41 and 42 can be omitted from the coin handling apparatus 1. The coin handling apparatus 1 with no recognition unit 7 does not have the timing sensor 71, and cannot identify the position of the coin 10 on the coin track 31 even when the coin handling apparatus 1 includes the encoder 83. However, the controller 100 can detect that the coin 10 has fallen into any one of the openings during the recovery from the transport error based on the detection results of the outlet sensors 101 to 106. The display 12 may only display the drawer 6 into which the coin 10 has fallen. Alternatively, if a plurality of coins 10 that has fallen is detected, the number of coins 10 fallen and the drawer 6 that received the coins 10 may be displayed together.

If the coin handling apparatus is configured such that the rotating shaft 82 of the transport disk 81 or a portion related to the driving of the rotating shaft 82 is locked when the motor 91 is stopped due to the occurrence of the transport error, and thus, the transport disk 81 and the rotating shaft 82 do not rotate when the transport disk 81 is detached from the rotating shaft 82, the movement of the coin 10 on the coin track 31 is restricted. In this case, the above-described control for detecting the fall of the coin 10 may be omitted. Even in the configuration in which the transport disk 81 and the rotating shaft 82 do not rotate, the coin 10 on the coin track 31 may possibly fall into any one of the openings by some chance, e.g., when the transport disk 81 is detached from the rotating shaft 82. Thus, the detection by the outlet sensors 101 to 106 may be performed during the recovery from the transport error.

Returning to Step S12 of the flow shown in FIG. 9, the controller 100 determines whether the feeding error has occurred. By comparing the detection results of the encoder 83 with the detection results of the photosensor 96, the controller 100 detects whether the feeding error has occurred.

As described with reference to FIG. 6, the rotating plate 22 of the feeding unit 2 is configured to be rotated by the second pulley 95 in contact with the back surface of the second belt 93. When the load of the rotating plate 22 increases due to the occurrence of the feeding error, slippage occurs between the second pulley 95 and the second belt 93. As a result, the rotation of the rotating plate 22 lags behind the rotation of the transport disk 81. In other words, the driving unit 9, having the single motor 91 as a driving source, is configured to drive the rotating plate 22 such that the slippage occurs when a load thereon increases.

If the controller 100 determines that the rotation of the rotating plate 22 detected by the photosensor 96 has lagged behind the rotation of the transport disk 81 based on the encoder pulse of the encoder 83 attached to the rotating shaft 82 of the transport disk 81, YES is selected in Step S12.

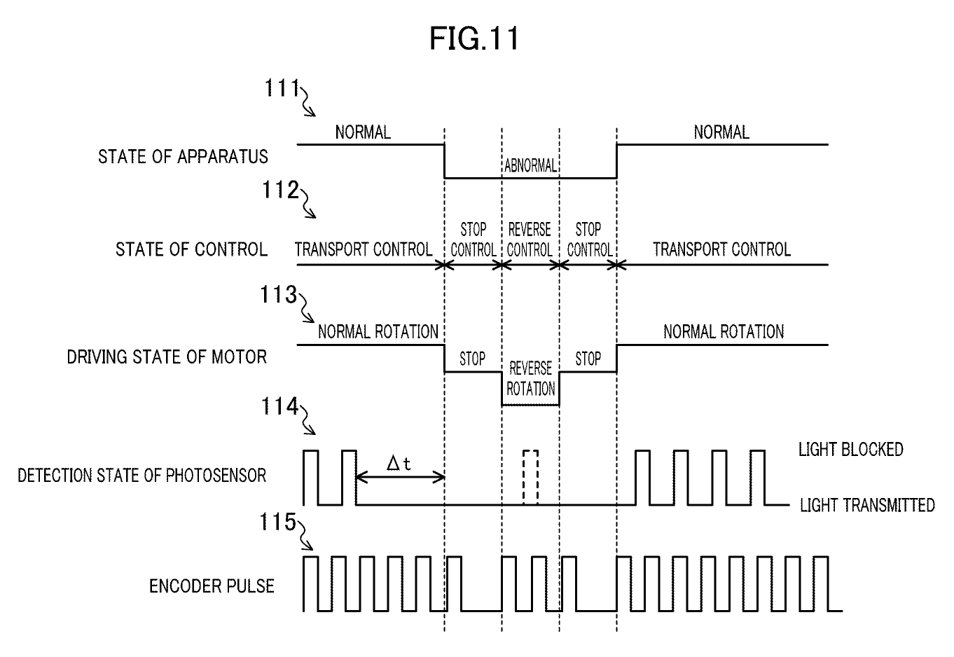

Specifically, as illustrated in a timing chart of FIG. 11, the controller 100 monitors a detection state (reference character 114) of the photosensor 96 and the encoder pulse (reference character 115) of the encoder 83. In the example in FIG. 11, for the sake of easy understanding, the encoder pulse 115 is expressed more roughly than actual ones. As for the detection signal 114 of the photosensor 96, the peak of a pulse waveform indicates the state in which light is blocked by the ribs 951 of the second pulley 95, and the bottom of the pulse waveform indicates the state in which light is transmitted. For the sake of easy understanding, the detection signal 114 of the photosensor 96 illustrated in FIG. 11 is also different from the actual one.

When the controller 100, receiving the encoder pulse 115, determines that no change in the detection signal 114 of the photosensor 96 has been observed for a predetermined jam time Δt, the controller 100 determines that the feeding error has occurred (reference character 111). Although the detection signal 114 of the photosensor 96 remains in the state of light transmission in the example in FIG. 11, the detection signal 114 may possibly remain in the state of blocking of light.

Further, if no coin 10 has come to the recognition unit 7 for a predetermined time even in the case where the detection signal 114 of the photosensor and the encoder pulse 115 are changing, it may be determined that the feeding error has occurred.

If the answer in Step S12 is YES, the process proceeds to Step S13. If the answer in Step S12 is NO, the process proceeds to Step S16 because neither the transport error nor the feeding error has occurred.

In Steps S13 to S15, the controller 100 automatically recovers from the feeding error. First, the controller 100 stops the motor 91 in Step S13. Subsequently, in Step S14, the controller 100 rotates the motor 91 in the reverse direction so that the rotating plate 22 rotates in a direction opposite to the feeding direction of the coins 10 (see also reference characters 112 and 113 in FIG. 11). With the rotating plate 22 rotating in the opposite direction, for example, jamming caused by the plurality of coins 10 overlapping each other can be solved, and accordingly, a cause of the feeding error can be removed.

Here, based on the encoder pulse 115, the controller 100 rotates the motor 91 in the reverse direction so that the angle of rotation in the opposite direction of the transport disk 81 is 10° or less. As described above, the driving unit 9 of the coin handling apparatus 1 is configured to rotate both of the rotating plate 22 and the transport disk 81 by the single motor 91. Thus, the rotation of the rotating plate 22 in the opposite direction is accompanied by the rotation of the transport disk 81 in the direction opposite to the transport direction of the coins 10. When the transport disk 81 rotates in the opposite direction, the coin 10 on the coin track 31 also moves in the opposite direction. If the angle of rotation in the opposite direction of the transport disk 81 is large, the coin 10 moves radially inward to be away from the arcuate reference edge 33. This may cause trouble in the movement and sorting of the coins 10 when the handling of the coin handling apparatus 1 is resumed. However, when the angle of rotation in the opposite direction of the transport disk 81 is 10° or less, the coins 10 on the coin track 31 can be blocked from moving away from the arcuate reference edge 33, and the coins 10 can be correctly and smoothly sorted after the restart of the handling. If the angle of rotation in the opposite direction of the transport disk 81 is too small, the recovery from the feeding error cannot be achieved with reliability. According to the inventors' study, the angle of rotation in the opposite direction of the transport disk 81 is preferably set to 3° to 5° because the recovery from the feeding error can be achieved with reliability and the coins 10 can be correctly and smoothly sorted after the restart of the handling.

Returning to Step S15 of the flow in FIG. 9, the controller 100 restarts the normal rotation of the motor. Thus, the coin handling apparatus 1 can automatically recover from the feeding error so that the coins 10 are continuously sorted. Since the coin handling apparatus 1 automatically recovers from the feeding error, the handling by the coin handling apparatus 1 is suspended less frequently, and the coin handling apparatus 1 can smoothly sort the coins.

In Step S16, the controller 100 determines whether the sorting of coins 10 has been finished. If the sorting has not been finished, the process returns to Step S2, and the sorting is continued. If the sorting is finished, the process ends.

If the recovery from the feeding error is impossible even through the reverse and normal rotations of the motor 91 in Step S14 and S15, the controller 100 may rotate the motor 91 in the reverse direction again. The rotation of the motor 91 may be reversed several times. However, if the angle of rotation in the opposite direction of the transport disk 81 is increased through such repeated reversal, trouble may possibly occur in the sorting when the sorting is restarted as described above. Therefore, the number of times of the reversal of the motor 91 may be limited to a predetermined number of times or less. If the recovery from the feeding error is impossible even through the predetermined number of times of the reversal, the controller 100 may stop the coin handling apparatus 1, and inform the operator of the occurrence of the feeding error. In this case, the operator manually recovers the apparatus from the feeding error.

Alternatively, the number of times of the reversal of the motor 91 may be limited to one. In this case, if the recovery from the feeding error cannot be achieved even after the rotation of the motor 91 is reversed in Step S14 and then the motor 91 is restarted to rotate in Step S15, the controller 100 stops the coin handling apparatus 1, and informs the operator of the occurrence of the feeding error.

When the coin handling apparatus 1 is stopped to inform the operator of the occurrence of the feeding error, the coin handling apparatus 1 can correctly inform the operator of the site where the error has occurred because the coin handling apparatus 1 is capable of detecting the occurrence of the feeding error in the feeding unit 2 in distinction from the transport error in the handling unit 3. As described above, the coin handling apparatus 1 is capable of detecting the occurrence of the transport error in the handling unit 3 in distinction from the feeding error in the feeding unit 2, and thus, is capable of correctly informing the operator of the site where the error has occurred.

As a result, the operator is only required to perform the recovery from the error at the informed site, that is, the feeding unit 2 or the handling unit 3. This can reduce the load of the operator.

As for the feeding by the feeding unit 2, as described above, the encoder pulse 115 and the detection signal 114 of the photosensor 96 are compared to determine that the rotation of the rotating plate 22 has relatively lagged behind the rotation of the transport disk 81. For example, when too many coins 10 are put into the feeding unit 2, the rotation load of the rotating plate 22 increases, and accordingly, the rotation of the rotating plate 22 relatively lags behind the rotation of the transport disk 81.

Therefore, if it is determined that the rotation of the rotating plate 22 has lagged for a predetermined time or longer behind the rotation of the transport disk 81 and no feeding error has occurred based on the comparison between the encoder pulse 115 and the detection signal 114 of the photosensor 96, the controller 100 may inform the operator, via the display 12, for example, that too many coins 10 have been dropped in the feeding unit 2, and the coins 10 should not be dropped any more. This can avoid the occurrence of the feeding error, and thus, the coin handling apparatus 1 can smoothly sort the coins.

If the rotation of the rotating plate 22 has relatively lagged behind the rotation of the transport disk 81, such a lag is considered as a sign of the feeding error, and the controller 100 may appropriately stop, reverse, or restart the motor 91 to avoid the occurrence of the feeding error.

Although the coin handling apparatus 1 is configured such that the transport disk 81 can be fully detached from the coin handling apparatus 1, the coin handling apparatus 1 may be configured such that the transport disk 81 lifted upward from the coin track 31 cannot be fully detached from the coin handling apparatus 1.

### DESCRIPTION OF REFERENCE CHARACTERS

1 Coin Handling Apparatus
10 Coin
12 Display (Display)
100 Controller (Controller)
2 Feeding Unit
22 Rotating Plate
31 Coin Track
41, 42 Driving Sorting Unit (Sorting Unit)
412, 422 Opening
51, 51, 52, 53, 54, 55, 56 Diameter-Sorting Unit (Sorting Unit)
511, 521, 531, 541, 551, 561 Opening
Recognition Unit
8 Transport Unit
81 Transport disk
83 Encoder (Rotational angle Detector)
91 Motor
92 First Belt
93 Second Belt
94 First Pulley
95 Second Pulley
951 Rib (Projection)
96 Photosensor (Rotational Speed Detector)
101 to 106 First to Sixth Outlet Sensors (Fall Detector)

1. A coin handling apparatus, comprising:
an arcuate coin track configured to move a coin;
a transport unit comprising a transport disk that rotates about a shaft, the transport disk rotating with pressing an upper surface of the coin by a lower surface of the transport disk so as to move the coin in a single layer and a single file along the coin track;
a sorting unit comprising a plurality of openings provided in the coin track, and configured to sort the coin by making the coin moving along the coin track fall into any of the openings;
a fall detector configured to detect the opening into which the coin has fallen;
a motor configured to allow the transport disk to rotate; and
a controller configured to stop the motor upon determining an occurrence of a transport error of the coin in the coin track, and identify the opening into which the coin has fallen in a period from the stop of the motor to the end of recovery from the transport error based on a detection result of the fall detector.

2. The coin handling apparatus of claim 1, wherein the transport disk is arranged to face the coin track so as to sandwich the coin between the lower surface of the transport disk and the coin track when the transport disk moves the coin, and the lower surface of the transport disk during the recovery from the transport error is at a position further away from the coin track than a position at which the transport disk moves the coin.

3. The coin handling apparatus of claim 1, further comprising:
a display configured to display the opening into which the coin has fallen in the period from the stop of the motor to the end of the recovery from the transport error.

4. The coin handling apparatus of claim 1, further comprising:
a rotational angle detector configured to detect an angle of rotation of the transport disk.

5. The coin handling apparatus of claim 1, further comprising:
a recognition unit configured to recognize the coin; and
a rotational angle detector configured to detect an angle of rotation of the transport disk, wherein the sorting unit comprises a driving sorting unit which is arranged downstream of the recognition unit in a direction of movement of the coin, and is configured to selectively drop the coin into an associated one of the openings based on a recognition result and the angle of rotation of the transport disk, and
the controller identifies, based on a detection result of the fall detector and a detection result of the rotational angle detector, a position of the coin in the period from the stop of the motor to the end of the recovery from the transport error, the coin having already passed through the recognition unit when the transport error occurred.

6. The coin handling apparatus of claim 5, further comprising:
a display configured to display an identification result of the controller,
wherein the display displays the opening into which the coin has fallen in the period from the stop of the motor to the end of the recovery from the transport error.

7. The coin handling apparatus of claim 6, wherein
the display displays a position of the coin remaining on the coin track.

8. The coin handling apparatus of claim 6, wherein
the display displays the opening into which the coin has fallen, and information based on the recognition result for identifying the coin that has fallen into the opening.

9. The coin handling apparatus of claim 8, wherein,
the controller determines, based on the recognition result, that the coin has fallen into an inappropriate one of the openings in a period from the stop of the motor to the end of the recovery from the transport error, and
the display displays that the coin has fallen into the inappropriate one of the openings.

10. The coin handling apparatus of claim 4, further comprising:
a feeding unit comprising a rotating plate that rotates about a shaft, and configured to separately feed the coins on the rotating plate to the coin track by rotation of the rotating plate;
a belt wound around a first pulley that is allowed to rotate by the motor and the shaft of the transport disk, and configured to transfer a rotary force of the motor to the transport disk; and
a second pulley attached to the rotating plate, and arranged to be in contact with a back surface of the belt between the first pulley and the shaft of the transport disk, so that the rotating plate rotates in a direction opposite to a direction of rotation of the transport disk while the belt is running.

11. The coin handling apparatus of claim 10, further comprising:
a rotational speed detector configured to detect a rotational speed of the rotating plate,
wherein the controller compares a detection result of the rotational angle detector and a detection result of the rotational speed detector to determine whether a feeding error has occurred in the feeding unit.

12. The coin handling apparatus of claim 11, wherein
the controller stops the motor and reverses the direction of rotation of the motor to allow the rotating plate to rotate in a direction opposite to a feeding direction of the coin upon determining that the feeding error has occurred, and then resumes driving the motor to allow the rotating plate to rotate in the feeding direction of the coin.

13. The coin handling apparatus of claim 12, wherein, the controller reverses the direction of rotation of the motor so that the transport disk rotates in the opposite direction at an angle of rotation of 10 degrees or less, when the controller rotates the rotating plate in the opposite direction.

14. The coin handling apparatus of claim 11, wherein the rotational angle detector is an encoder provided for the shaft of the transport disk and configured to output a signal to the controller in accordance with the rotation of the transport disk.

15. The coin handling apparatus of claim 11, wherein the rotational speed detector detects that a projection provided for the rotating plate revolves in accordance with the rotation of the rotating plate.
